(19) United States
(12) Patent Application Publication
(10) Pub. No.: US 2014/0323251 A1
(43) Pub. Date: Oct. 30, 2014

(54) Baseball Bat Survival Apparatus

(71) Applicant: Jordan James Estrada, Leesburg, CA (US)

(72) Inventor: Jordan James Estrada, Leesburg, CA (US)

(21) Appl. No.: 14/198,617

(22) Filed: Mar. 6, 2014

Related U.S. Application Data
(60) Provisional application No. 61/775,624, filed on Mar. 10, 2013.

(51) Int. Cl. A63B 59/00; A62B 99/00

(52) U.S. Cl. CPC A63B 59/007; A62B 99/00
USPC 473/564

(57) ABSTRACT

A hollow and open-ended baseball bat containing a survival kit secured inside the bat by a removable end cap and designed to be used in an emergency situation as both a blunt impact weapon, and as a means of carrying the survival kit.

### CROSS REFERENCE TO RELATED APPLICATIONS

The present application claims priority from U.S. Provisional Application Ser. No. 61/775,624; Baseball Bat Survival System, filing date Mar. 10, 2013 by inventor Jordan J. Estrada. Applicant claims priority under 35 U.S.C. .sctn.119 as to the said U.S. provisional application.

### BACKGROUND OF THE INVENTION

1. Field of the invention

This invention relates to the field of tactical and survival gear. More specifically, this invention consists of a baseball bat, with a an enclosed cavity within the bat. A removable cap or lid conceals the cavity, and can be opened or removed to reveal the cavity. The hollow cavity inside the bat contains a survival kit. The removable cap allows the survival kit to be contained inside the hollow cavity when the cap is attached, or removed from the hollow cavity when the cap is detached. Furthermore, the baseball bat itself is the designated weapon of this survival apparatus.

2. Description of Related Art

In recent years, the concept of an emergency escape container holding an essential supply of tactical and first aid gear has become increasingly commercially available. These emergency kits are designed to be readily accessible and easily transported in an emergency evacuation. Many times, an emergency bag or survival kit includes some kind of defensive or offensive weapon.

The container of the survival kit can also function as a piece of the survival kit. For example, several knife survival kits feature a hollow cavity in the handle of the knife. The hollow cavity contains other pieces of the survival kit, while the knife itself serves as the designated weapon and tool in the survival kit. The knife is therefore both a part of the survival kit, and the container of the survival kit.

### BRIEF SUMMARY OF THE PRESENT INVENTION

The Baseball Bat Survival Apparatus applies these ideas by allowing survival gear to be stored inside a very popular self-defense weapon—a baseball (or softball, T-ball) bat. A bat by the door or nightstand has historically been a first choice home defense weapon for people in all walks of life. In the event that an emergency retreat or evacuation is acquired, the Baseball Bat Survival Apparatus allows the user to immediately grab both a weapon and a survival kit at the same time, in one hand. The modification of the baseball bat to include a removable and securable cap allows the user to utilize the bat as a weapon while retaining the survival items safely inside. The contents of the bat can be emptied and refilled at the will of the user, and all the while, retain its function as a blunt striking implement.

Regarding its construction, the Baseball Bat Survival Apparatus will consist of a baseball, softball, or T-ball bat, or a baseball, softball, or T-ball shaped aluminum, steel, plastic, or composite tube. The bat will be hollow, with an opening at one end of the bat revealing the hollow cavity. The hollow cavity will be loaded with a survival kit.

The open, hollow end of the bat will be covered and secured with a removable cap. The removable cap will be an expansion or compression plug, threaded cap, clamp fitting, hinged cap, or any other mechanical cap or plug designed to both attach and detach. The cap will be designed to be removed by hand, with some tool by, or be means of a nut nob, threaded cap, threaded handle, nut cap, wing nut, bolt, hinged clasp, or mechanical release.

### BRIEF DESCRIPTION OF THE SEVERAL VIEWS OF THE DRAWING

FIG. 1.A Is a perspective view, showing the present invention with the removable cap attached to the bat

FIG. 1.B Is a perspective view, showing the present invention with the cap removed from the bat

FIG. 2.A Is a perspective view, showing how the survival kit is stored inside the hollow bat

FIG. 2.B Is an exploded perspective view showing how removal of the cap allows the survival kit to be accessed.

FIG. 3. Shows how the removable cap is meant to be removed by pulling the cap from the bat.

FIG. 4. Shows how the removable cap is meant to be removed by twisting or unscrewing it from the bat.

FIG. 5. Shows how the removable cap is meant to be removed by flipping it off the bat by a hinge.

FIG. 6.A Shows how the removable cap may be attached to the bat by means of a male threading on the cap which screws onto the female threads of the bat

FIG. 6.B Shows how the removable cap may be attached to the bat by means of a female threading on the cap which screws onto the male threads of the bat

FIG. 7. Shows how the removable cap may be attached to the bat by means of an expansion plug that is inserted into the bat's cavity and tightened by a wing nut, nut knob, screw, or other device.

FIG. 8. Shows how the removable cap may be attached to the bat by means of a compression fitting that is inserted into the bat's cavity and tightened by a wing nut, nut knob, screw, or other device.

FIG. 9. Shows how the removable cap may be attached to the bat by means of an expander plug that is inserted into the bat's cavity and tightened by a wing nut, nut knob, screw, or other device.

FIG. 10. Shows how the removable cap may be attached to the bat by means of a hinged lid.

### REFERENCE NUMERALS IN THE DRAWING

1 The baseball bat survival apparatus
2 The removable cap or lid
3 The hollow cavity within the bat
4 The grip of the bat
5 The survival kit contained in the hollow cavity of the bat
6 The cap removed by pulling
7 The cap removed by twisting or unscrewing
8 The cap removed by flipping
9 The threaded removable cap designed to screw onto the threaded bat and seal the hollow cavity within the bat
10 The threaded bat designed to accept the threaded cap
11 The expansion plug removable cap designed to fit into and seal the hollow cavity within the bat
12 The hand-operated knob to release the expansion plug from the bat
13 The compression fitting removable cap designed to fit into and seal the hollow cavity within the bat
14 The expander plug removable cap designed to fit into and seal the hollow cavity within the bat
15 The hinged lid removable cap designed to cover and seal the hollow cavity within the bat

### DETAILED DESCRIPTION OF THE INVENTION

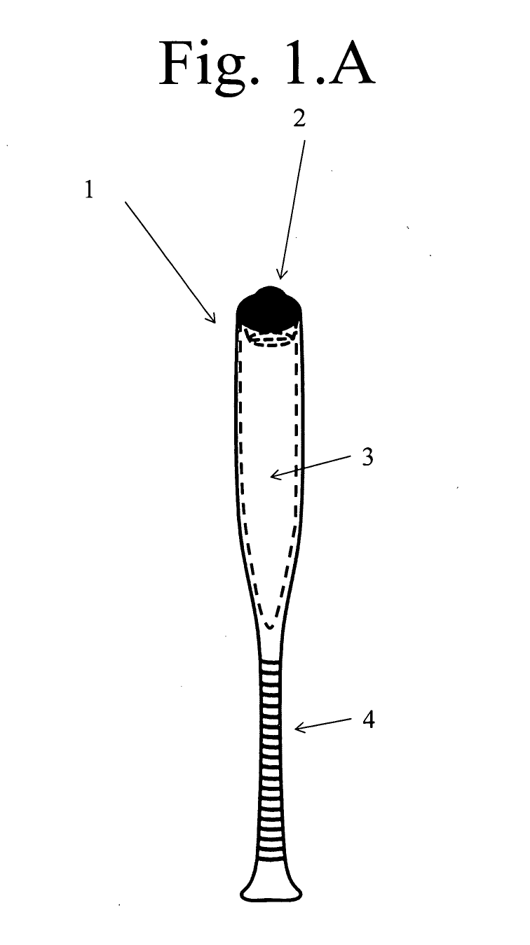

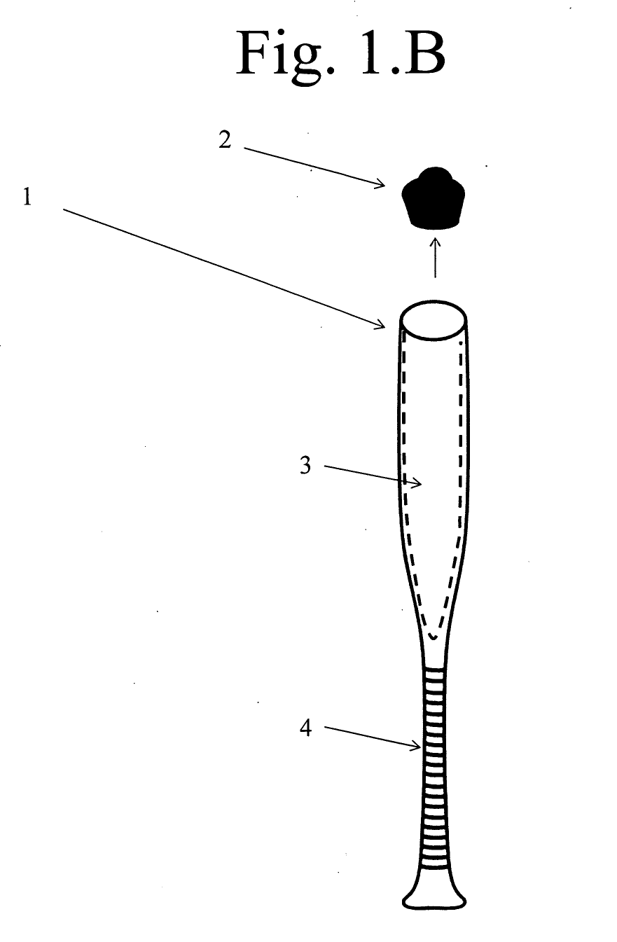

FIG. 1.A and 1.B show the basic external view of the Baseball Bat Survival Apparatus. The external features consist of a baseball, softball, T-ball bat or baseball, softball, or T-ball bat shaped aluminum, steel, plastic, or composite tube (1), and a removable cap in place of the traditional permanent plastic cap or aluminum rolled over end of the bat (2). The cap seals the hollow cavity within the bat (3). The handle of the bat is covered with a grip (4).

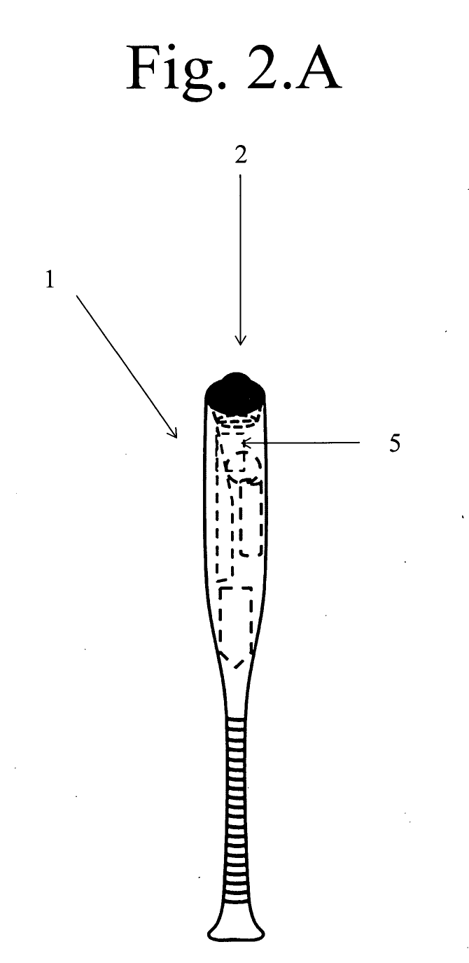

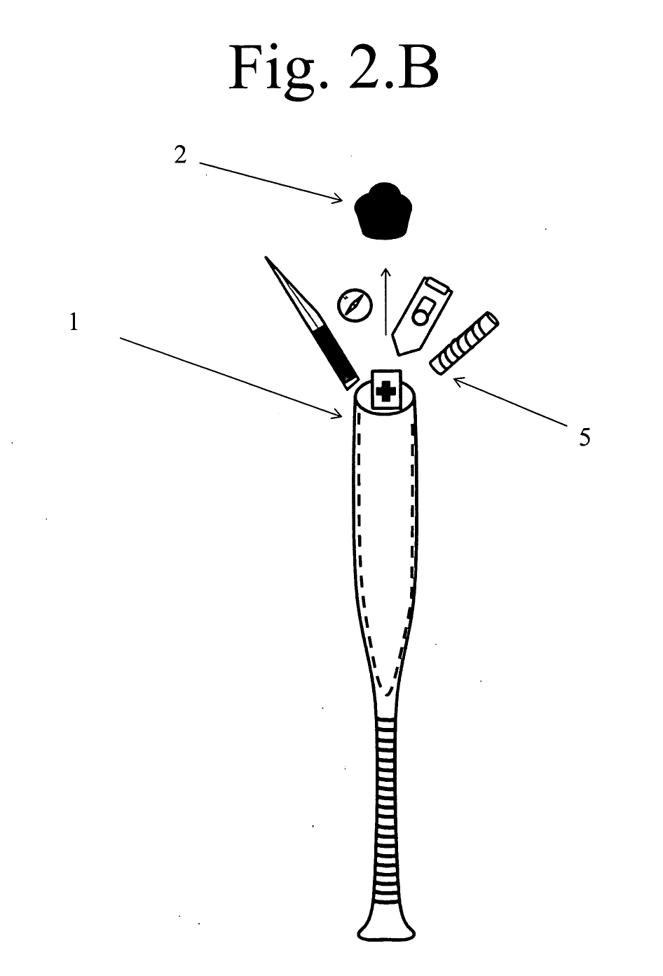

FIG. 2.A and 2.B show how the survival kit (5) is stored inside the hollow cavity within the bat (3) and removing the cap (2) gives access to the survival kit. When the cap is in place, the survival kit is concealed and contained. When the cap is removed, the survival kit is visible and accessible.

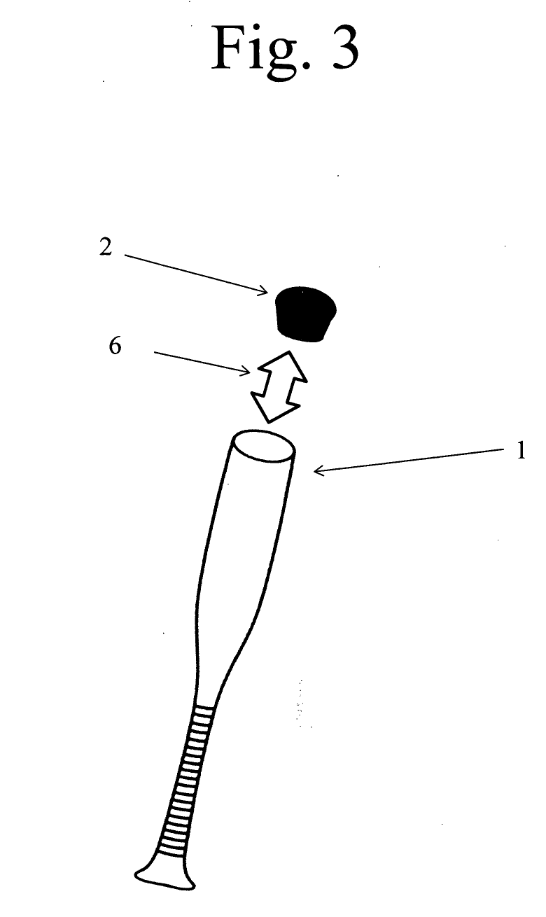

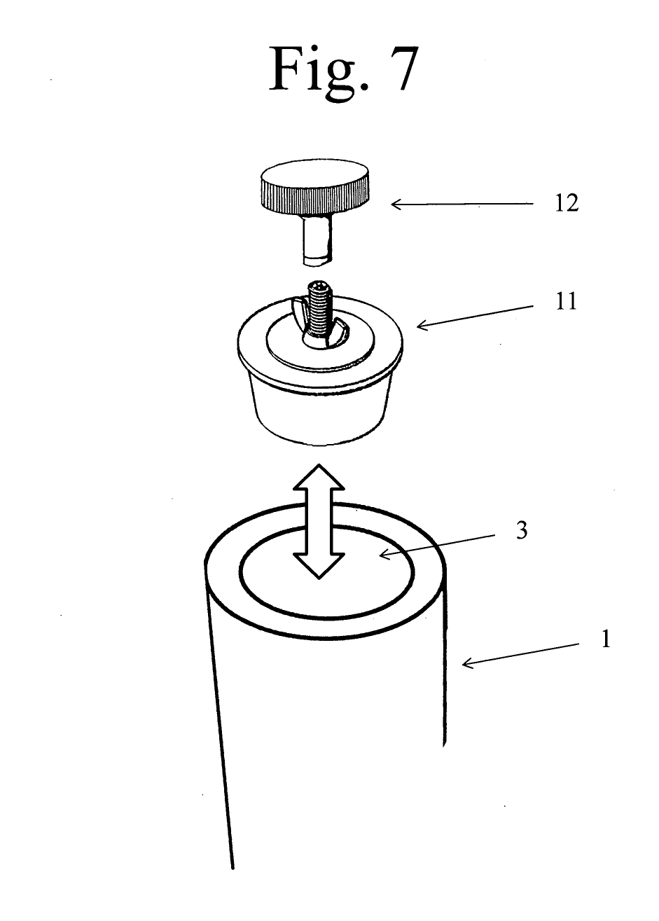

FIG. 3 shows how the cap can be removed from the bat by pulling it out of and away from the hollow cavity of the bat (6). FIGS. 7, 8, and 9 demonstrate an end cap that is removed from the bat by this action.

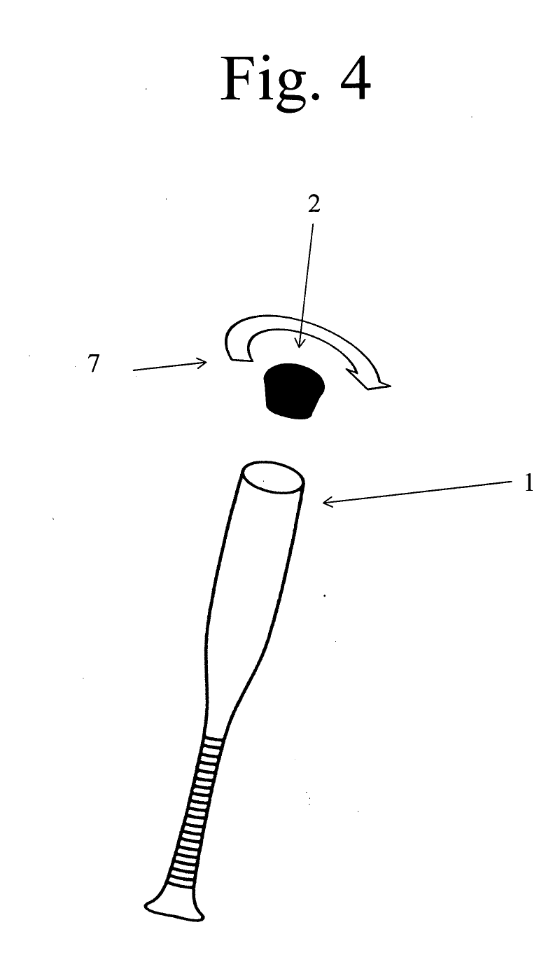

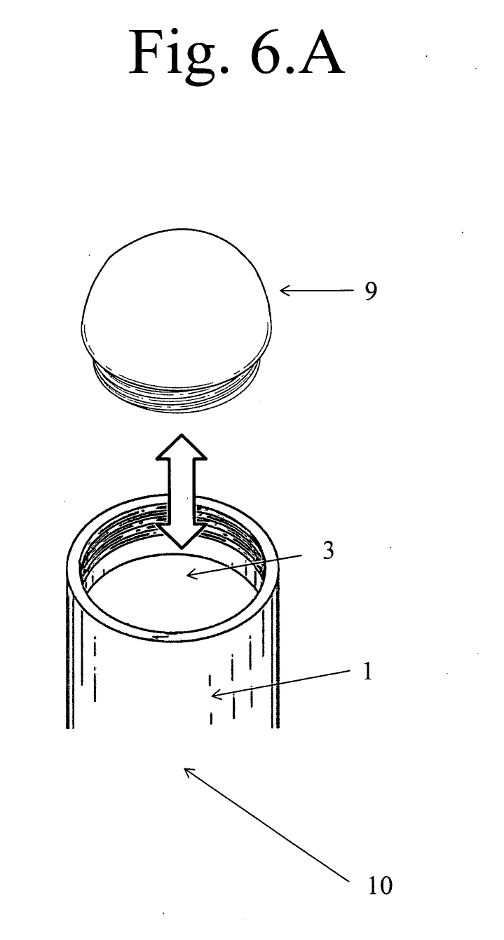

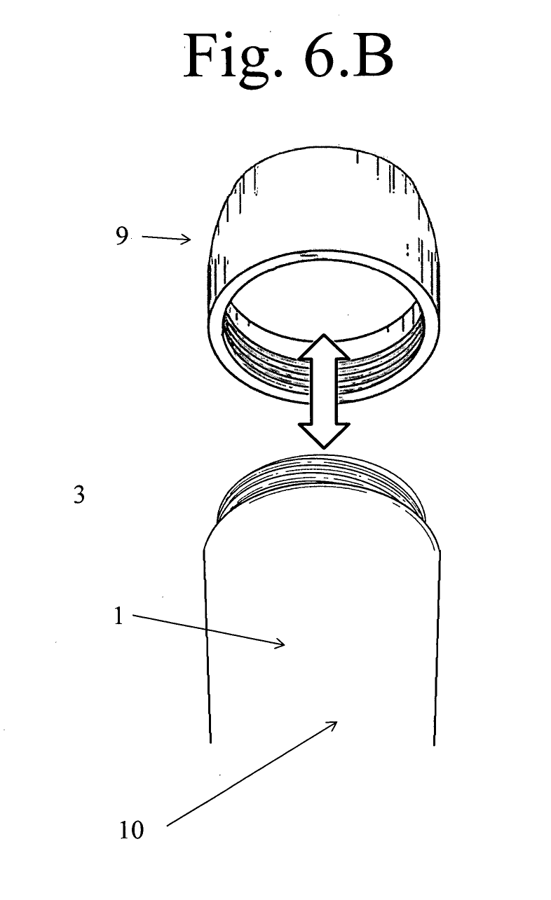

FIG. 4 shows how the cap can be removed from the bat by twisting or unscrewing it from the bat (7). FIG. 6 demonstrates an end cap that is removed from the bat by this action.

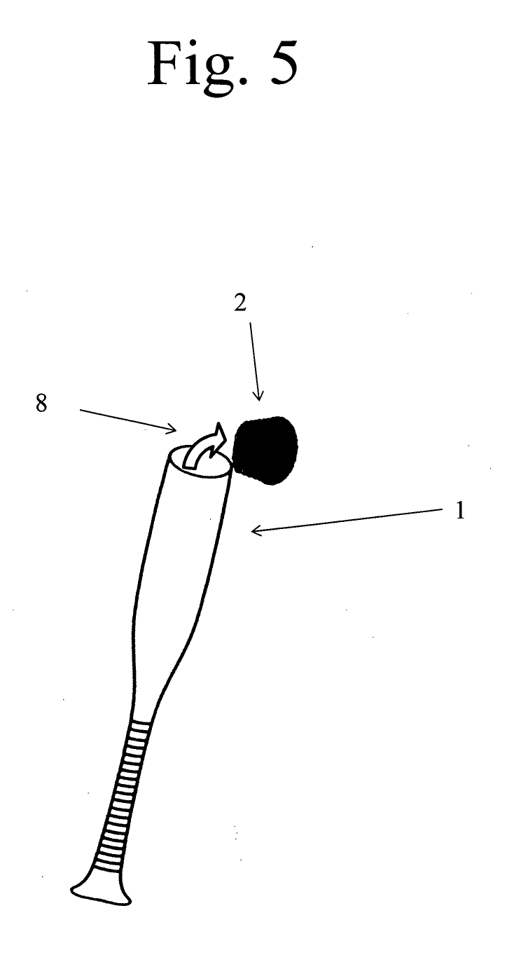

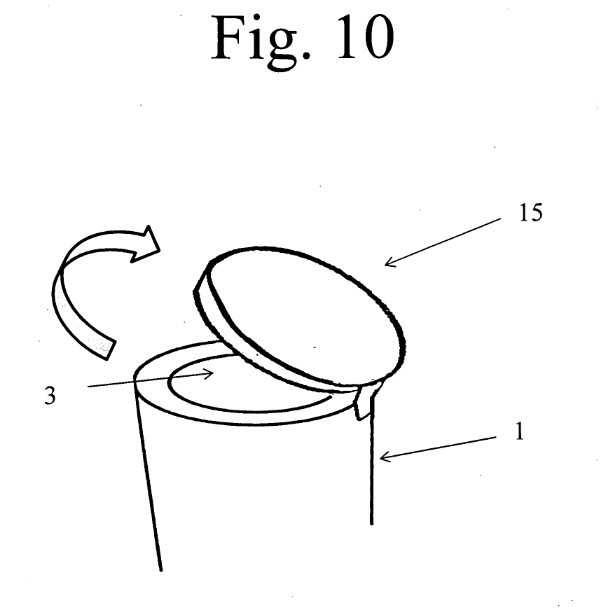

FIG. 5 shows how the cap can be removed from the bat by flipping (8) the cap away from the bat and to the side by means of a hinge. FIG. 10 demonstrates an end cap that is removed from the bat by this action.

FIG. 6.A and 6.B demonstrate the Baseball Bat Survival Apparatus (1) with a removable cap that has threads (9) that allow it to screw onto the threaded bat (10). As shown in FIG. 6, the cap may be female threaded and the bat male threaded, or the bat female threaded and the cap male threaded. The cap screws onto the bat, concealing the hollow cavity within the bat (3) and containing the survival kit inside the bat. The cap is removed by unscrewing it from the bat, revealing the hollow cavity inside the bat to access the survival kit inside the bat.

FIG. 7 demonstrates the Baseball Bat Survival Apparatus (1) with a removable cap that is an expansion plug (11). When the expansion plug is partially inserted into the hollow cavity within the bat (3), the knob or wing nut (12) attached to the expansion plug is twisted, activating the expansion plug and causing it to seal the hollow cavity of the bat and secure the survival kit inside the bat. When the knob or nut is twisted in the opposite direction, the expansion plug shrinks, unsealing the hollow cavity of the bat and allowing access to the survival kit inside the bat.

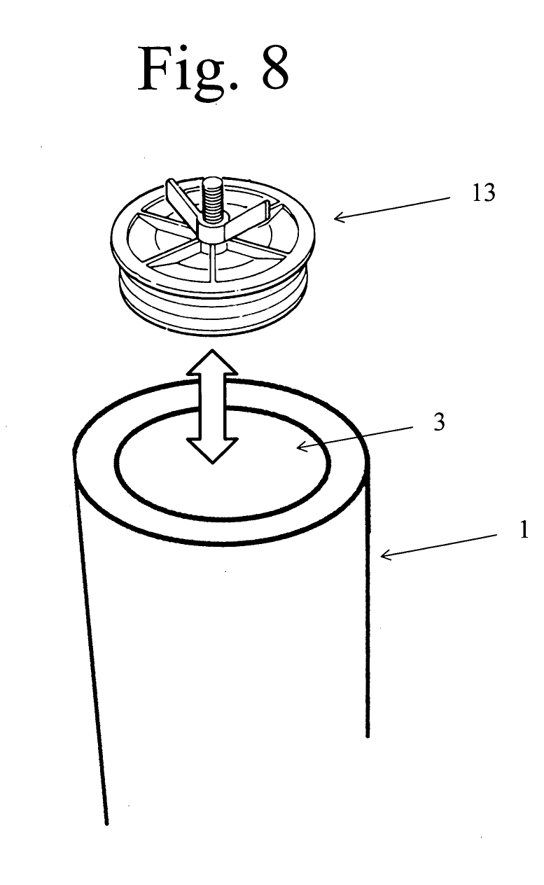

FIG. 8 demonstrates the Baseball Bat Survival Apparatus (1) with a removable cap that is a compression fitting (13). When the compression fitting is partially inserted into the hollow cavity within the bat (3), the knob or wing nut attached to the compression fitting is twisted, activating the compression fitting and causing it to seal the hollow cavity of the bat and secure the survival kit inside the bat. When the knob or nut is twisted in the opposite direction, the compression fitting is deactivated, unsealing the hollow cavity of the bat and allowing access to the survival kit inside the bat.

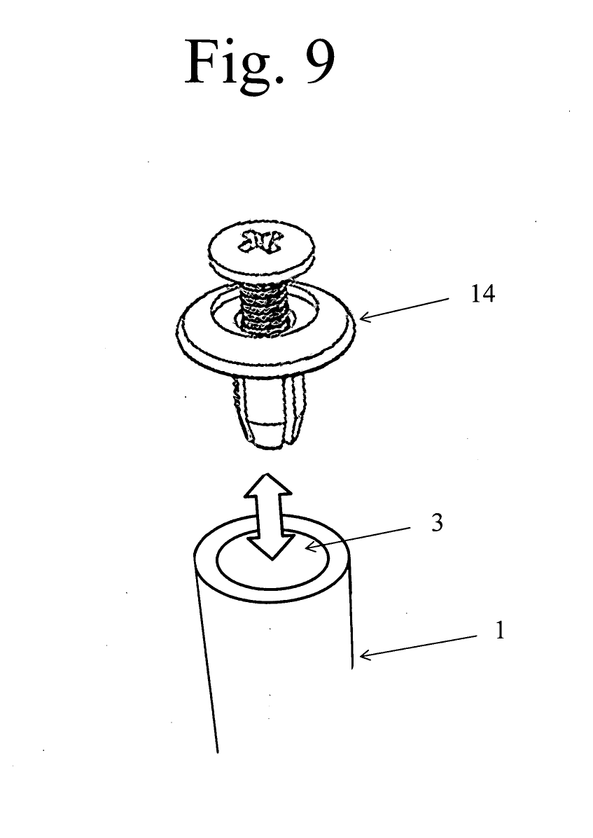

FIG. 9 demonstrates the Baseball Bat Survival Apparatus (1) with a removable cap that is an expander plug (14). When the expander plug is partially inserted into the hollow cavity within the bat (3), a screw attached to the expander plug is tightened, activating the expander plug and causing it to seal the hollow cavity of the bat and secure the survival kit inside the bat. When the screw is turned in the opposite direction, the expander plug is deactivated, unsealing the hollow cavity of the bat and allowing access to the survival kit inside the bat.

FIG. 10 demonstrates the Baseball Bat Survival Apparatus (1) with a removable cap that is an hinged lid (15). The hinged lid can be closed over the hollow cavity within the bat (3), sealing the hollow cavity of the bat and securing the survival kit inside the bat. The hinged lid is flipped open to reveal the hollow cavity of the bat and allow access to the survival kit inside the bat.

Although the proceeding descriptions contain significant detail, they should not be construed as limiting the scope of this invention, but rather as providing an illustration of the preferred iteration of this invention. As an example, both the survival contents and the removable cap or plug could take on many different forms. One alternative would be a threaded plug with a reversible spear or dagger point on the underside. By reversing the threaded plug, the end of the bat could be converted into a spear or edged weapon. Another example would be a custom-made mechanically released cap that fits over or inside the hollow cavity at the end of the bat. Such a variation would not materially alter the nature and spirit of the invention. Thus, the scope of the invention should be fixed by the following claims rather than by any specific examples provided.

Having described my invention, I claim:

1. A survival apparatus consisting of:
a. A bat
b. A cavity within the bat
c. An opening at one end of the bat adjacent to the cavity
d. A survival kit inside the cavity within the bat
e. A removable cap that covers the opening adjacent to the cavity within the bat
f. Whereby the survival kit can be contained within the hollow cavity of the bat when the cap is attached and withdrawn from the hollow cavity of the bat when the cap is detached.

2. A survival apparatus according to claim 1 wherein the opening at the end of the bat is threaded and the removable cap is threaded such that the cap can be screwed onto the bat and the cavity is thereby enclosed.

3. A survival apparatus according to claim 1 wherein the removable cap is an expansion plug that can be partially inserted into the opening at the end of the bat and, when expanded, the cavity is thereby enclosed.

4. A survival apparatus according to claim 1 wherein the removable cap is a compression fitting that can be partially inserted into the opening at the end of the bat and, when compressed, the cavity is thereby enclosed.

5. A survival apparatus according to claim 1 wherein the removable cap is a expander plug that can be partially inserted into the opening at the end of the bat and, when expanded, the cavity is thereby enclosed.

6. A survival apparatus according to claim 1 wherein the removable cap is a hinged lid that can be lowered over the opening at the end of the bat, whereby the cavity is enclosed.
